(19) United States
(12) Patent Application Publication
(10) Pub. No.: US 2010/0101102 A1
(43) Pub. Date: Apr. 29, 2010

(54) Container piercing device

(75) Inventor: Semor D. Tofte, Mankato, MN (US)

Correspondence Address: Lee Pederson, 712 East Main Street, Sleepy Eye, MN, 56085, US

(73) Assignee: Cadit, a Minnesota Limited Liability Corporation

(21) Appl. No.: 12/589,642

(22) Filed: Oct. 27, 2009

Related U.S. Application Data
(60) Provisional application No. 61/197,513, filed on Oct. 28, 2008.

(51) Int. Cl. B67B 7/48

(52) U.S. Cl. 30/443

(57) ABSTRACT

A metal piercing device is useful for creating vent holes in containers. The device has ergonomic and safety features including a removable guard that protects from accidental exposure to the piercing element while doubling as a hanger.

### RELATED APPLICATIONS

This application claims priority based on provisional U.S. Patent Application Ser. No. 61/197,513 entitled “Container Piercing Device” and filed on Oct. 28, 2008.

### FIELD OF THE INVENTION

The present invention relates to kitchen devices. More particularly, the present invention is a manually operated hand-held device that is used to safely and easily pierce the wall of a container to create vent or drain openings. It is especially useful for facilitating the removal of semisolid, dimensionally stable or liquid packed food products from cylindrical containers.

### BACKGROUND OF THE INVENTION

Atmospheric pressure working against a vacuum sealed by the highly viscous contents of a container creates a force resistant to movement that can be many times the weight of the contents. Breaching the seal equalizes pressure and reduces the force required to remove the contents to that required to overcome friction between the container and the contents.

Dimensionally stable contents such as mashed products, loaf-style dog food, meat products, jell-like products and the like are only with great difficulty removed as an integral unit from an unvented container. Removing dimensionally stable contents in segments by slicing or spooning is difficult and may result in product loss. Dimensionally stable contents may be removed with little loss from a vented container by moderately shaking the inverted and opened container to overcome friction between the container walls and the contents.

Semisolid contents such as condensed products and the like are difficult to remove from an unvented container without spooning. Semisolid contents may be almost entirely removed from a vented container by controlling the container in a manner that prevents the contents from slumping inside the container as they are removed.

Three-piece containers are constructed with rims on both ends and may be safely vented by using a beverage can piercer “church key” or a can opener to vent the end opposite the open end. Two-piece containers are made with a seamless cup-shaped bottom that does not permit the use of either a standard can opener or can piercer to create a vent in the bottom wall.

It is inadvisable to use piercing tools such as leather awls, ice picks and the like as they are not intended to be used for piercing metal and these tools require great care whenever they are handled to avoid injury from the sharp point.

It would be desirable to have a hand-held device to pierce the walls of a thin-walled container for the purpose of venting or draining the contents. Furthermore, there is a need for the device to pierce the rimless end of a two-piece container. Still further, it would also be desirable to guide the piercing element during operation and limit exposure to the sharp piercing point at all times. Therefore, there currently exists a need in the industry for a piercer that can be used with minimal training by experienced food preparers on the majority of currently available containers.

### BRIEF DESCRIPTION OF THE INVENTION

A metal piercing device is useful for creating vent holes in containers. The device has ergonomic and safety features including a removable guard that protects from accidental exposure to the piercing element while doubling as a hanger.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a perspective view of a piercing device positioned over a container that is to be pierced.

FIG. 2 is a vertically cross-sectioned perspective view of the piercing device.

FIG. 3 is a removable hanger/safety guard.

FIG. 4 is a perspective view of the device with the hanger/safety guard installed.

### DETAILED DESCRIPTION

Embodiments of the present invention are described herein in the context of a metal piercing device. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

Those of ordinary skill in the art will realize that the following description of the present invention is illustrative only and not in any way limiting. Other embodiments of the invention will readily suggest themselves to such skilled persons having the benefit of this disclosure.

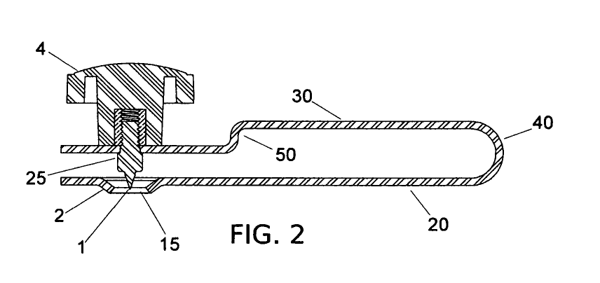

Referring now to FIG. 2, the device comprises a base plate 20 and a spring arm 30. In the embodiment shown, the base plate and spring arm are integrally formed from the same piece of metal and joined by a curvature 40 at the handle end of the device. A flange 2 extends downward from the bottom of base plate 20. A piercing assembly is comprised of a knob 4, a conical point 1 and a cylinder 25. The piercing assembly attaches to the device through an aperture in the spring arm. The conical point and cylinder may be integrally formed. The cylinder may be substituted for by extending the wide end of the conical point. All the figures show the spring arm in the relaxed position, in which conical point 1 is protected from exposure. When force is exerted downward on knob 4, the spring arm bends down into the extended position and conical point 1 then extends through aperture 15 in base plate 20.

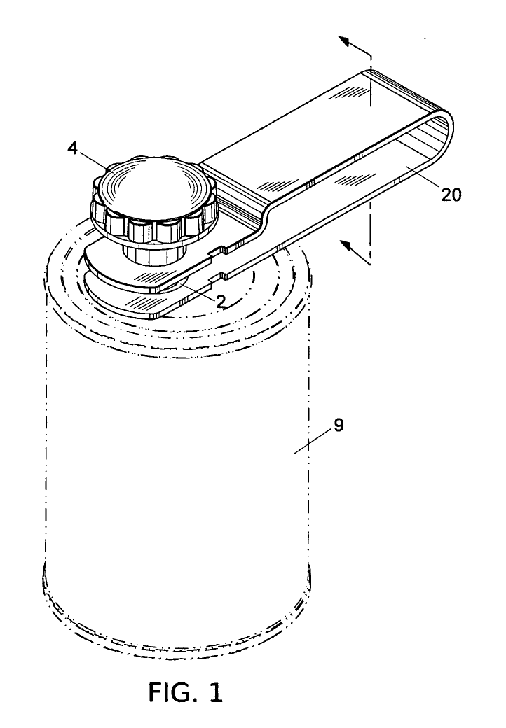

The spring arm 30, base plate 20 and flange 2 are manufactured using conventional stamping and plating processes. Conical point 1 and knob 4 are attached to the spring arm 30 by a self-clinching or conventionally threaded means. The travel required to pierce the container (9 in FIG. 1) is limited by a double bend 50 in the spring arm 30 near the piercing assembly to improve stability. The combination of the curvature 40 and the double bend 50 optimize durability, stability and flexibility while reducing the force needed for operation of the device.

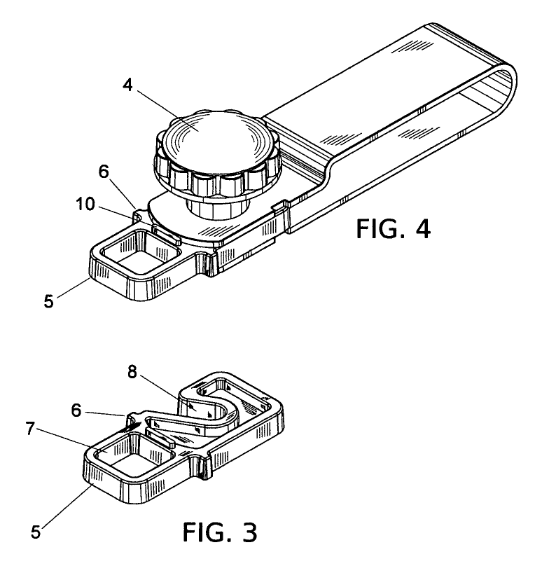

Referring now to FIG. 3, the safety guard/hanger 5 is fabricated with a suitable plastic material using a conventional injection molding process. The hanger is attached to the device by aligning the diagonal slot 8 longitudinally with the device body and in line with the conical point and/or cylinder. The hanger is rotated into the position shown in FIG. 4 after sliding the hanger completely onto the conical point and/or cylinder. The locking projection 10 holds the hanger into place until the hanger is rotated to a removal position. The hanger 5 may be moved into position for additional protection against damage from or to the sharp point of the conical point 1 during handling and storage. A cable tie (not shown) may be installed for shipping and retail sales display. The cable tie secures the safety guard to the piercing unit. The cable tie may additionally secure a display card to the device. It will be appreciated that the cable tie may be secured in any of several configurations.

To use the invention, an unopened container is placed on a suitable work surface with the end to be opened facing down and the end to be pierced facing up. As shown in FIG. 1, the device is placed upon the container with the knob 4 facing up. A downward pressure is applied to the knob 4 until the container wall is pierced and the conical point 1 is at the end of the stroke. After piercing, the spring arm 30 causes the conical point 1 to lift and exit the pierced hole when pressure is released on the knob 4. This operation may be repeated as necessary to create the desired number of vent holes.

Once the vents have been made, the user removes the lid from the non-vented end of a container and places the downward facing open end over a transfer container. The user applies a moderate up and down shaking motion to the container to cause the dimensionally stable contents to be removed from the container as an integral unit. The process is similar for containers with semisolid or liquid packed contents.

The present invention is superior when compared to other known devices or solutions because the present invention provides a compact and stable platform to safely and easily pierce vent or drain openings in all commonly used food containers. Furthermore the present invention has features that allow it to be safely and effectively displayed in a retail environment with minimal packaging waste.

Advantages of the invention include a piercing element that is held by a spring in a position that prevents damage to the sharp point or from the sharp point when not in use. Overall design allows positioning the piercing element within any stiffening ridges of the container at an angle nearly vertical to the surface of the container. A safety guard is provided to positively hold the piercing element in a safe position. The safety guard may double as a hanger. A single cable tie is all that is required to secure the hanger into position during shipping and retail display.

Features such as a magnet for storage and lifting lids may be added to the invention. The invention may also be integrated with other devices, especially can openers or pop-top lifters.

In one aspect, the invention is a device for piercing holes. The device comprises a piercing unit comprising a base plate having an upper surface, a lower surface, a handle end and a piercing end, and having an aperture near the piercing end; a spring arm movable between a relaxed conformation and an extended conformation, said spring arm positioned substantially in parallel above the base plate, the spring arm having an upper surface, a lower surface, a handle end and a piercing end, and having an aperture at a distance between about 2 to 10 millimeters above the aperture in the base plate when the spring arm is in the relaxed conformation; and

a piercing assembly fixed in the aperture of the spring arm, the piercing assembly comprised of a knob, and a conical point. The device further comprises a safety guard having a thickness about equal to the distance between the upper surface of the base plate and the lower surface of the spring arm when the spring arm is in the relaxed position. The safety guard is removably positionable between the base plate and the swing arm.

The conical point extends below the lower surface of the base plate when the spring arm is in the extended conformation and does not extend below the surface of the base plate when the spring arm is in the relaxed conformation. The device may further comprise a flange projecting around the aperture on the lower surface of the base plate. The spring arm may include a double bend between the aperture in the spring arm and the handle end of the spring arm.

The distance between the base plate and the spring arm is between about 8 and 15 millimeters at the handle end and between about 2 and 10 millimeters at the apertures when the spring arm is in the relaxed position. The base plate and the spring arm may be integrally formed of the same piece of metal curved at the handle end.

The distance between the apertures is preferably between about 5 to 8 millimeters when the spring arm is in the relaxed conformation. The base plate preferably has a thickness between about 1.0 and 1.8 millimeters, and more preferably about 1.5 millimeters. The distance between the handle end of the base plate and the piercing end of the base plate is preferably between and 9 and 15 centimeters. The aperture in the base plate may be circular. The base plate may be between about 1 and 3 centimeters in width.

The piercing assembly may further comprise a cylinder interposed between the knob and the conical point. The cylinder and the conical point may be integrally formed. The piercing end of the base plate may be defined by an arc with its center at the same point as the center of the aperture of the base plate. The safety guard may include a diagonal slot having the same width as the diameter of the cylinder. The inner end of the diagonal slot may be curved to accommodate the cylinder and to allow rotation between the piercing unit and the safety guard. The safety guard may further comprise a locking projection that fits against the curved end of the base plate when the safety guard is positioned between the base plate and the spring arm and the diagonal slot is engaged with the cylinder.

The safety guard may extend beyond the piercing end of the piercing unit when the safety guard is positioned between the base plate and the spring arm. The portion of the safety guard that extends beyond the piercing end of the piercing unit when the safety guard is positioned between the base plate and the spring arm may define a hole or a hook. The device may further comprise a cable tie preventing separation of the piercing unit and the safety guard while the cable tie is intact.

The knob has two main purposes. First, the knob is used to secure the conical point in position of the aperture of the spring arm. Second, the knob provides an ergonomic surface for the user to apply pressure. The knob may be implemented in a variety of embodiments, as long as it serves one or both of these purposes.

Conical points are preferred for piercing. Preferably, the point is designed to produce a hole between about 1 to 3 millimeters in diameter, and more preferably about 2 millimeters in diameter. Such a hole is large enough for venting air but small enough to resist leakage of semisolid contents. It will be appreciated that the size of the hole produced will equal the maximum diameter of the point that extends below the lower surface of the base plate when the spring arm is in the extended position. When a flange is present, the flange is considered to be part of the lower surface of the base plate.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A device for piercing holes, the device comprising:
a piercing unit comprising
a base plate having an upper surface, a lower surface, a handle end and a piercing end, and having an aperture near the piercing end;
a spring arm movable between a relaxed conformation and an extended conformation, said spring arm positioned substantially in parallel above the base plate, the spring arm having an upper surface, a lower surface, a handle end and a piercing end, and having an aperture at a distance between about 2 to 10 millimeters above the aperture in the base plate when the spring arm is in the relaxed conformation; and
a piercing assembly fixed in the aperture of the spring arm, the piercing assembly comprised of a knob and a conical point; and
a safety guard having a thickness about equal to the distance between the upper surface of the base plate and the lower surface of the spring arm when the spring arm is in the relaxed position, said safety guard removably positionable between the base plate and the swing arm.

2. The device of claim 1, where the tip of the conical point extends below the lower surface of the base plate when the spring arm is in the extended conformation and does not extend below the surface of the base plate when the spring arm is in the relaxed conformation.

3. The device of claim 1, where the lower surface of the base plate further comprises a flange projecting around the aperture.

4. The device of claim 1, where the spring arm includes a double bend between the aperture in the spring arm and the handle end of the spring arm.

5. The device of claim 4, where the distance between the base plate and the spring arm is between about 8 and 15 millimeters at the handle end and between about 2 and 10 millimeters at the apertures when the spring arm is in the relaxed position.

6. The device of claim 1, where the base plate and the spring arm are integrally formed of the same piece of metal curved at the handle end.

7. The device of claim 1, where the distance between the apertures is between about 5 to 8 millimeters when the spring arm is in the relaxed conformation.

8. The device of claim 1, where the base plate has a thickness of about 1.5 millimeters.

9. The device of claim 1, where the distance between the handle end of the base plate and the piercing end of the base plate is between and 9 and 15 centimeters.

10. The device of claim 1, where the aperture in the base plate is circular.

11. The device of claim 1, where the piercing assembly further comprises a cylinder interposed between the knob and the conical point.

12. The device of claim 11, where the cylinder and the conical point are integrally formed.

13. The device of claim 12, where the piercing end of the base plate is defined by an arc with its center at the same point as the center of the aperture of the base plate.

14. The device of claim 13, where the safety guard includes a diagonal slot having the same width as the diameter of the cylinder.

15. The device of claim 14, where the inner end of the diagonal slot is curved to accommodate the cylinder and to allow rotation between the piercing unit and the safety guard.

16. The device of claim 15, where the safety guard further comprises a locking projection that fits against the curved end of the base plate when the safety guard is positioned between the base plate and the swing arm and the diagonal slot is engaged with the cylinder.

17. The device of claim 1, where the safety guard extends beyond the piercing end of the piercing unit when the safety guard is positioned between the base plate and the spring arm.

18. The device of claim 18, where the portion of the safety guard that extends beyond the piercing end of the piercing unit when the safety guard is positioned between the base plate and the spring arm defines a hole or a hook.

19. The device of claim 1, where the base plate is between about 1 and 3 centimeters in width.

20. The device of claim 1, further comprising a cable tie preventing separation of the piercing unit and the safety guard while the cable tie is intact.
